(19) United States
(12) Patent Application Publication
(10) Pub. No.: US 2016/0018612 A1
(43) Pub. Date: Jan. 21, 2016

(54) SYSTEMS AND METHODS FOR CABLE DISTRIBUTION

(71) Applicant: OFS FITEL, LLC, Norcross, GA (US)

(72) Inventors: Wladyslaw Czosnowski, Duluth, GA (US); Harold P Debban, Snellville, GA (US); Daniel Hendrickson, Roswell, GA (US); Peter A Weimann, Atlanta, GA (US)

(73) Assignee: OFS FITEL, LLC, NORCROSS, GA (US)

(21) Appl. No.: 14/625,711

(22) Filed: Feb. 19, 2015

Related U.S. Application Data
(60) Provisional application No. 62/024,582, filed on Jul. 15, 2014.

(51) Int. Cl. G02B 6/44

(52) U.S. Cl. CPC G02B 6/441

(57) ABSTRACT

A fiber-optic system is disclosed in which a self-supporting cable comprises self-supporting break-out sub-cables, which provide fiber-optic connectivity to customer premises.

### CROSS REFERENCE TO RELATED APPLICATIONS

This application claims the benefit of U.S. provisional patent application Ser. No. 62/024,582, filed 2014 Jul. 15, having the title “Outside Plant Cable Distribution System”; U.S. provisional patent application Ser. No. 62/026,847, filed 2014 Jul. 21, having the title “Outside Plant Cable Distribution System”; U.S. provisional patent application Ser. No. 62/041,249, filed 2014 Aug. 25, having the title “Duraline Future Path Aerial With Pulling Tape”; U.S. provisional patent application Ser. No. 62/043,016, filed 2014 Aug. 28, having the title “Duraline Future Path Aerial With Pulling Tape”; all of which are incorporated herein by reference in their entireties.

### BACKGROUND

1. Field of the Disclosure

The present disclosure relates generally to optics and, more particularly, to fiber-optic cables.

2. Description of Related Art

Optical-fiber-based systems are playing a larger role in data communications as customer demand for data capacity increases. For example, fiber-to-the-premises (FTTX) systems permit direct optical connections to the home or other premises, thereby providing greater access to data. Consequently, there are ongoing efforts to improve FTTX systems as customer demands for data continue to increase.

### SUMMARY

The present disclosure provides cables for providing fiber-optic connections to customer premises. For some embodiments, the cables comprise break-out sub-cables, each of which is self-supporting. Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram showing one embodiment of a cable comprising break-out sub-cables, which provide optical connections in a fiber-to-the-premises (FTTX) environment.

FIG. 2 is a diagram showing one embodiment of the cable of FIG. 1.

FIG. 3 is a diagram showing another embodiment of the cable of FIG. 1.

FIG. 4 is a diagram showing a cross-sectional view of the cable of FIG. 3 with multiple break-out sub-cables.

FIG. 5 is a diagram showing a cross-sectional view of the break-out sub-cable of FIG. 4.

FIG. 6 is a diagram showing another embodiment of a cable comprising break-out sub-cables.

FIG. 7 is a diagram showing yet another embodiment of a cable comprising break-out sub-cables.

### DETAILED DESCRIPTION OF THE EMBODIMENTS

Fiber-optic networks are playing a larger role in data communications as customer demand for data capacity increases. Lately, there have been increasing demands for fiber-to-the-premises (FTTX) systems, which permit direct optical connections to the home or other premises. In an FTTX system, a main optical cable is terminated near a home or other customer location and a drop cable from the termination point on the main cable is brought to the home or other customer location. Conventionally, the process of terminating and installing the drop cable assembly was done at the customer location, thereby resulting in significant labor in the field at the termination point. This is because the drop assembly process typically requires: (a) opening a portion of an outer jacket of the main cable at the termination location; (b) exposing an optical fiber from within the main cable; (c) terminating the exposed optical fiber, which is done on-site at the termination point; (d) connecting the drop cable; and then (e) somehow sealing or protecting the connection point so that the connection is not vulnerable to moisture or other elements. Typically, the cost of on-site installation increases relatively linearly for each FTTX customer location.

In order to avoid the costs that are associated with on-site termination and on-site connectorization, others have pre-fabricated cables with pre-connectorized termination points. Thus, instead of increasing the on-site costs associated with FTTX installation, these alternative processes increase the design and manufacturing costs at the factory. In other words, for pre-connectorized cables, the process often requires: (a) precision measurement of the distances to customer locations on a potential cable route; (b) using those measurements to determine termination locations on a main cable; (c) pre-connectorizing (or splicing in a premade factory pigtail) an optical fiber in the cable at the factory; (d) installing the cable with the pre-connectorized fiber; and (e) connecting a drop cable to the pre-connectorized fiber at a FTTX customer premises.

While the pre-connectorization process decreases the on-site (customer location) installation costs, it increases the factory manufacturing costs. However, one advantage of pre-connectorizing the cable at the factory is that the termination (or connectorization) process takes place in a controlled environment (in the factory), rather than in a variable environment (at each different customer location).

One drawback of conventional pre-connectorized cable assemblies—has been that they often require physical closures to protect inner units of the assemblies from outside plant (OSP) elements (e.g., moisture, vermin, etc.). Furthermore, conventional pre-connectorization assemblies typically require environmental and/or mechanical protection of the exposed optical fiber at the termination point. This is because much of the strength elements are removed at the termination point in order to access the optical fiber for pre-connectorization. In other words, there is an added cost because strength members are removed to access the optical fiber, and then strength members are added back to reinforce the optical fiber.

The various embodiments address these and other shortcomings associated with conventional pre-connectorized cables by providing an OSP-rated self-supporting cable with OSP-rated self-supporting break-out sub-cables and by factory pre-connectorizing the sub-cables. Since each of the sub-cables is effectively a stand-alone OSP-rated fiber-optic cable, there is no need to provide additional reinforcement after pre-connectorization. In other words, unlike conventional pre-connectorization processes that require reinforcement of the pre-connectorized optical fiber, the disclosed embodiments comprise fiber-optic sub-cables that need no additional reinforcement or special protection from the elements after pre-connectorizing.

Having provided a general description of one embodiment of a pre-connectorized cable with break-out sub-cables, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

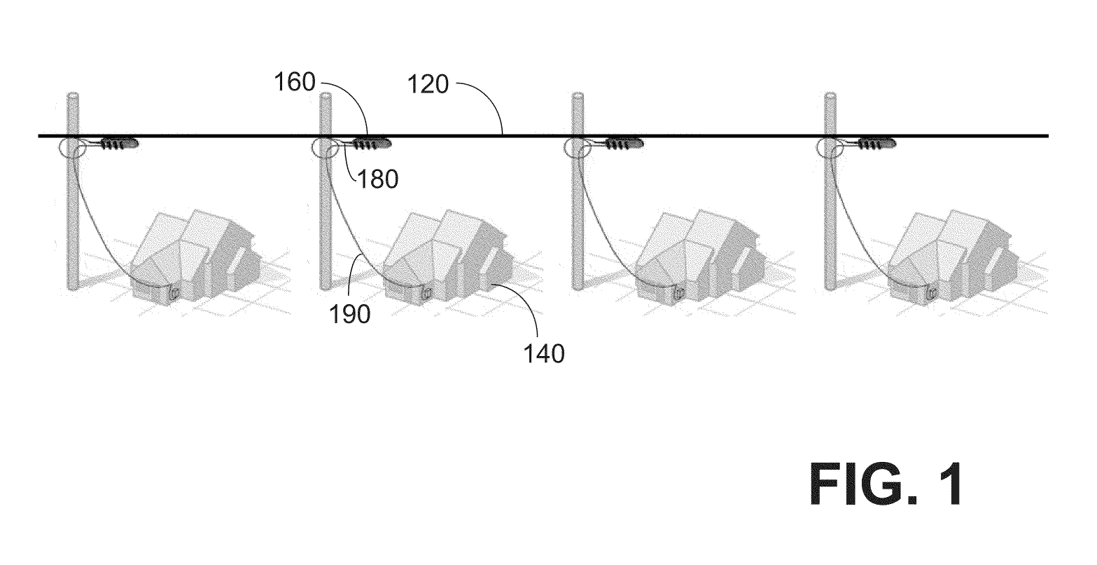

FIG. 1 is a diagram showing one embodiment of a cable comprising break-out sub-cables, which provide optical connections in a fiber-to-the-premises (FTTX) environment in an aerial FTTX application. In particular, FIG. 1 shows a FTTX environment with multiple customer premises 140 (e.g., homes, business, other customer locations) that are serviced by a main fiber-optic cable 120. It should also be noted that the break-out sub-cables can also be applied to FTTX environments having buried cables. As shown in FIG. 1, the main cable 120 comprises a sub-cable 180 that is connected to a drop cable 190 through a connector assembly 160. The connector assembly 160 can include many different types of connectors, such as, for example, multi-fiber in-line adapters, fan-out connectors, single-fiber connectors, and other known fiber-optic connectors (e.g., conventional connectors used in drop cable assemblies). Since the drop cable 190 provides an optical connection between the customer premises 140 and the main cable 120, for some embodiments both the drop cable 190 and the main cable 120 are OSP-rated self-supporting fiber-optic cables. Furthermore, as shown in FIG. 1, multiple customer premises 140 are serviced through multiple corresponding drop cables 190 and multiple connector assemblies 160, all of which branch from the main cable 120. Those having skill in the art will appreciate that, for buried cable applications, the ability to remove sub-elements (e.g., sub-cables) permits adjustments that may be required due to inaccurate measurements of a route or unknown variables in the route. Furthermore, the ability to remove long lengths of sub-cables eliminates the need for local splice joints to be added.

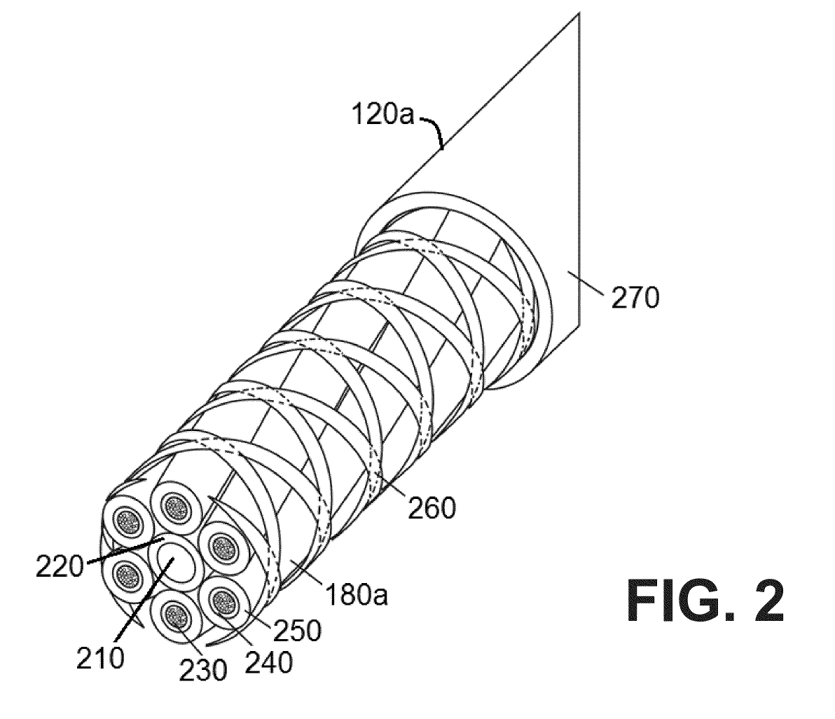

With this FTTX environment in mind, attention is turned to FIG. 2, which shows one embodiment of the cable 120 of FIG. 1. In particular, FIG. 2 shows one embodiment of a cable 120a with multiple sub-cables 180a (six are shown). As shown in FIG. 2, the cable 120a is an OSP-rated self-supporting main cable with a center member 220 having a strength element 210 along a length of the main cable 120a. The sub-cables 180a are self-supporting OSP-rated break-out fiber-optic cables, which are positioned substantially parallel to the strength element 210. It should be appreciated that the sub-cables 180a can also be arranged in substantially-helical or substantially-reverse-oscillating configurations around the strength element 210. Each sub-cable 180a comprises optical fibers 230, which are surrounded by sub-cable aramid yarn 240 that runs largely parallel to the optical fibers 230. A sub-cable jacket 250 surrounds the optical fibers 230 and the sub-cable aramid yarn 240, thereby providing protection for the optical fibers 230. The sub-cables 180a are helically wrapped by aramid strands used as binder yarns 260, which hold the sub-cables 180a together and provide additional reinforcement for the cable 120a. For the embodiment of FIG. 2, a main cable jacket 270 surrounds all of these components, thereby offering an additional protection to the sub-cables 180a from the environment and the elements. However, it should be appreciated that other binder yarns or tapes can be used in place of the aramid yarn, and that the binder yarns or tapes can be advantageously coated with weather-resistant coatings so that the cable jacket may be stripped and the cable core may be directly exposed to elements without substantial adverse consequences.

Although not shown in FIG. 2, one can appreciate that each sub-cable 180a can be connectorized and used with a drop cable as shown in the environment of FIG. 1. Specifically, the sub-cables 180a can be factory-terminated prior to installation and, given that each of the sub-cables 180a are self-supporting OSP-rated fiber-optic cables, no additional reinforcement is necessary after termination at the factory.

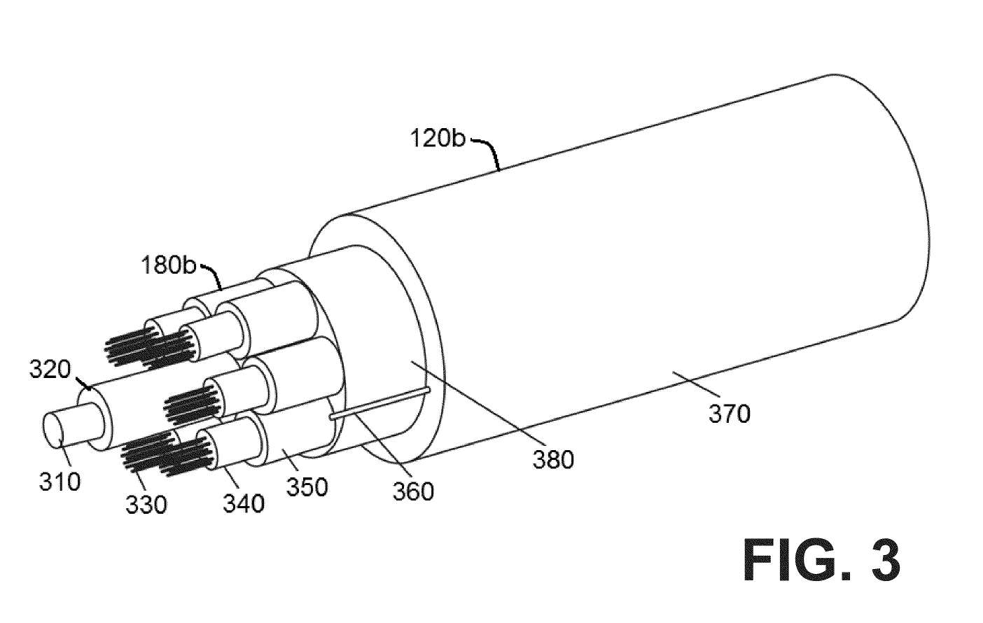

FIG. 3 is a diagram showing another embodiment of the cable of FIG. 1. As shown in the embodiment of FIG. 3, the system comprises a main cable 120b with multiple sub-cables 180b. Preferably, both the main cable 120b and the sub-cables 180b are self-supporting OSP-rated fiber-optic cables. The main cable 120b comprises a center member 320 with a strength element 310 positioned along a length of the main cable 120b. Surrounding the center member 320 are the sub-cables 180b that run substantially parallel to each other or in a helical fashion about the center member 320. Each sub-cable 180b comprises one or more optical fibers 330, a sub-cable strength element 340, and a sub-cable jacket 350. For some embodiments, the sub-cable strength element 340 comprises aramid yarn that reinforces the strength of the sub-cable 180b. In addition to the central strength element 310 and a ripcord 360, the cable 120b further comprises aramid yarn 380 that surrounds the sub-cables 180b, thereby providing additional reinforcement to the cable 120b. A cable jacket 370 surrounds all of the previously-recited components to protect them from the elements (e.g., moisture, ultraviolet (UV) radiation, pests and other vermin, etc.).

Again, while not shown in FIG. 3, each sub-cable 180b can be connected in a FTTX system to a drop cable through a connector assembly. Thus, the sub-cables 180b can be factory-terminated with no need for additional reinforcement after termination at the factory.

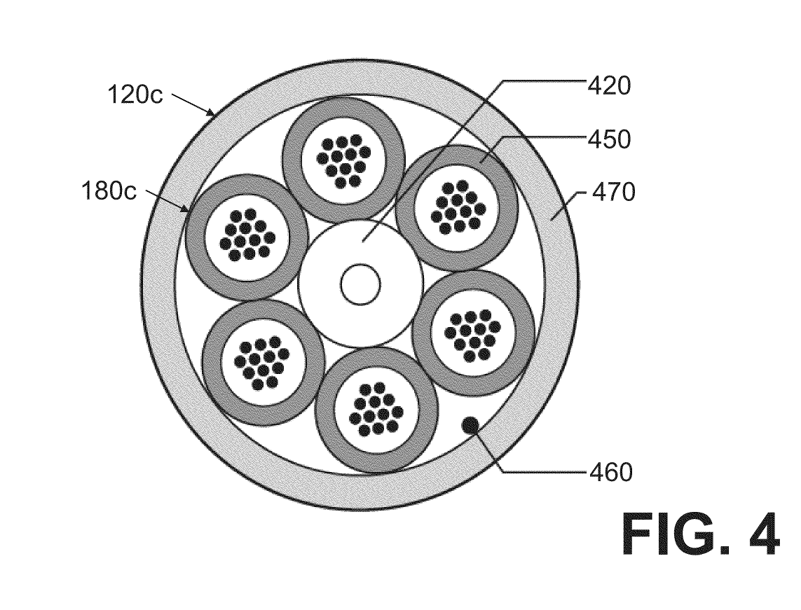

FIG. 4 is a diagram showing a cross-sectional view of the cable of FIG. 3 with multiple break-out sub-cables. In particular, FIG. 4 shows a cross-section of a 72-fiber cable 120c, which includes six (6) sub-cables 180c, each with twelve (12) fibers that are arranged in a closely-packed matrix. For simplicity, only a center member 420, sub-cable jacket 450, main cable jacket 470, and the ripcord 460 are labeled in FIG. 4. However, one should appreciate that all of the components that are described with reference to FIG. 3 are also present in FIG. 4.

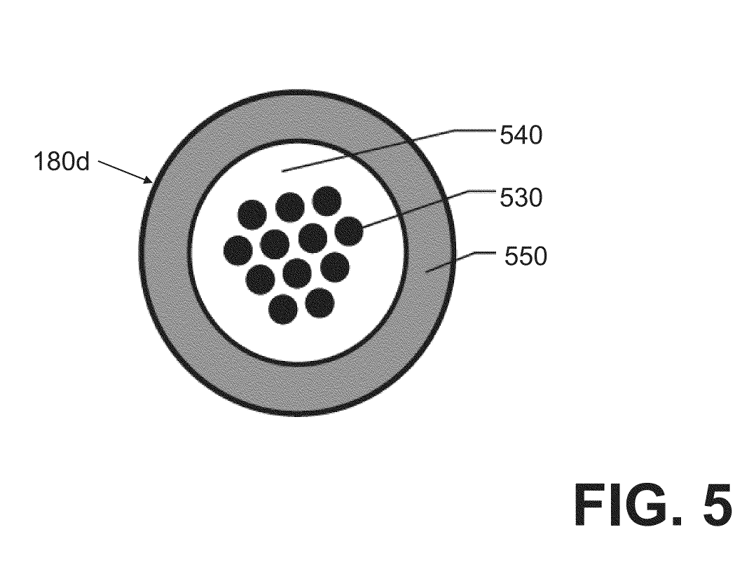

FIG. 5 is a diagram showing a cross-sectional view of the break-out sub-cable of FIG. 4. Specifically, FIG. 5 shows a sub-cable 180d with twelve (12) optical fibers 530 that are arranged in a substantially close-packed arrangement and surrounded by a sub-cable strength member 540, such as aramid yarn, which run parallel to the optical fibers 530. The optical fibers 530 and the strength member 540 are surrounded by a sub-cable jacket 550, which protects the optical fibers 530 from external elements, thereby making the sub-cable 180d an OSP-rated fiber-optic cable. As one can appreciate, although a 12-fiber arrangement is shown in FIG. 5, the sub-cable can comprise any number (m) of optical fibers to make a m-fiber sub-cable. Furthermore, although a close-packed arrangement of optical fibers is shown in FIG. 5, it should be appreciated that the layout of optical fibers in the sub-cable can be changed (e.g., to ribbon configurations, etc.) to suit varying needs. Using a m-fiber sub-cable as an example, one having skill in the art will appreciate that, for the environment of FIG. 1, the connector assembly 160 may comprise m optical connectors, with each of the m optical connectors terminating a corresponding one of the m optical fibers. Another possibility is to have some or all fibers in a cable sub-unit arranged in form of m fiber ribbons, with m being an integer value. In such embodiment one can envision the ribbon to be terminated by a multi-fiber connector and later through a fan-out into individual fibers leading to premises. An additional embodiment comprises a sub-cable with m loose fibers terminated into a m-fiber multi-fiber connector, using techniques well known to one skilled in the art, and later through a fan-out into individual fibers leading to premises.

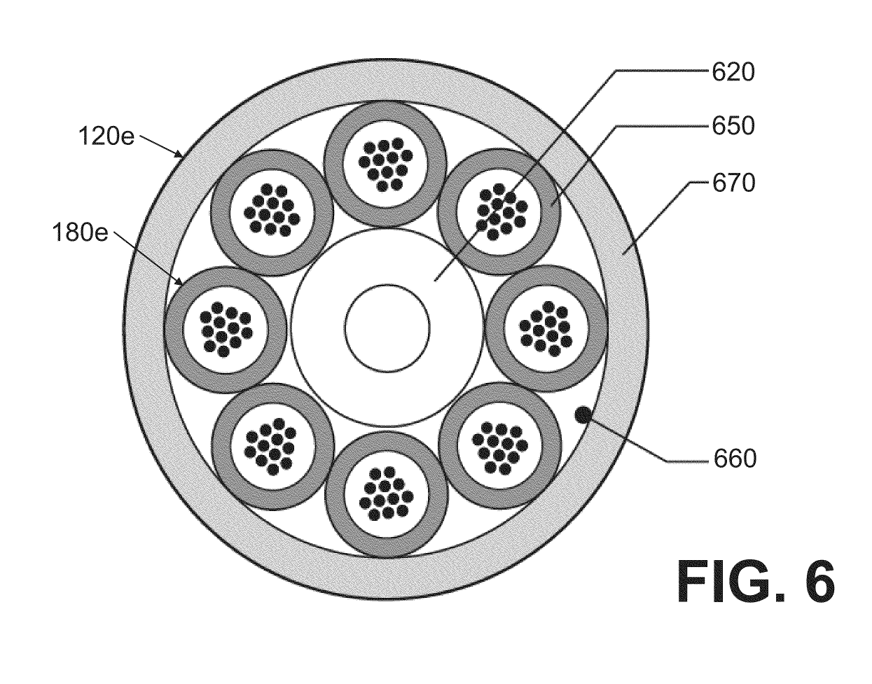

FIG. 6 is a diagram showing another embodiment of a cable 120e comprising sub-cables 180e. Similar to FIG. 4, to avoid clutter, only the center member 620, sub-cable jacket 650, main cable jacket 670, and the ripcord 660 are labeled, but one having skill in the art will appreciate that the cable 120e and sub-cables 180e comprise similar components as shown in FIGS. 3 and 4. Specifically shown in FIG. 6 is a 96-fiber cable 120e with eight (8) 12-fiber sub-cables 180e. The twelve (12) fibers within each sub-cable 180e are arranged in a substantially close-packed arrangement. The embodiment of FIG. 6 permits connection of at least eight (8) neighborhood locations, where each of the twelve (12) fibers in the eight (8) subunits reaches a different customer property (potentially, up to 96) within one of the neighborhood locations.

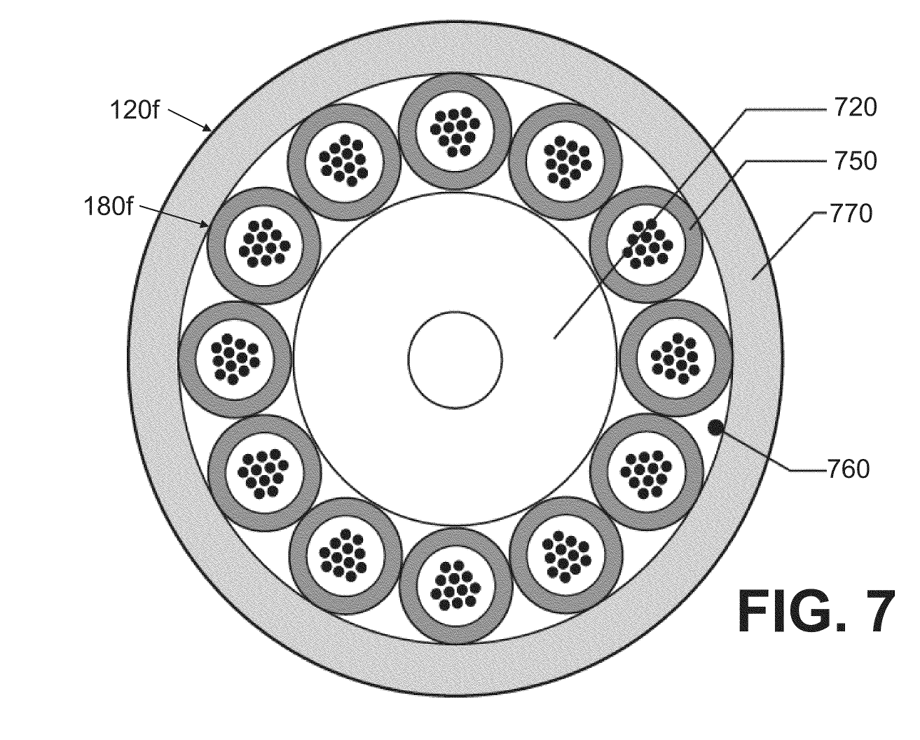

FIG. 7 is a diagram showing yet another embodiment of a cable 120f comprising break-out sub-cables 180f. Once again, to avoid a crowded drawing, only the center member 720, sub-cable jacket 750, cable jacket 770, and ripcord 760 are labeled. Specifically, FIG. 7 shows a 144-fiber cable 120f with twelve (12) sub-cables 180f. Each sub-cable 180f comprises twelve (12) optical fibers that are arranged in a substantially close-packed matrix. Given the twelve (12) sub-cables 180f, the embodiment of FIG. 7 permits drop cable installation for at least twelve (12) locations and ultimately 144 customer premises.

The sub-cables 180 shown in the embodiments of FIGS. 1 through 7 can be used for drop cable installation by terminating and pre-connectorizing the sub-cables 180 at the factory (instead of at the installation site). The process for pre-connectorizing the sub-cables 180 comprises the step of determining the termination locations in the cable 120 and then factory terminating the sub-cables at those determined locations by factory installing connectors (or connector assemblies) at those termination points.

Since the sub-cables 180 are self-supporting OSP-rated fiber-optic cables, there is no need to provide additional reinforcements after pre-connectorization. Furthermore, as shown in FIGS. 4, 6, and 7, the cable 120 is relatively modular in design because it permits different numbers of sub-cables 180 to be aggregated together to form the cable 120. Furthermore, since the sub-cables 180 are OSP-rated, the cable 120 does not require all of the closure items that are present in conventional pre-connectorized drop-cable assemblies, since many of the inner components are already protected by the components that form the sub-cable 180. Significantly, the embodiments of FIGS. 2 through 7 permit direct factory termination at the end-points of the sub-cables 180, and further permits scaling at the fiber layer by changing the number of optical fibers in each sub-cable 180. Insofar as each sub-cable 180 is OSP-rated and self-supporting, the embodiments of FIGS. 2 through 7 dispense with the need for reinforcement that may be required in conventional pre-connectorization processes. Additionally, one should appreciate that any unused sub-cable 180, located down the stream from the termination point (away from the splice closure or FDH cabinet) also provides additional strength to the cable 120, regardless of the number of terminated subunits of the main cable 120.

Although exemplary embodiments have been shown and described, it will be clear to those of ordinary skill in the art that a number of changes, modifications, or alterations to the disclosure as described may be made. For example, although the cables 120 show a cable jacket surrounding the sub-cables 180, it should be appreciated that the sub-cables 180 may be lashed together using environmentally-resistant binder strands and, being OSP rated, the cable may have no need for an additional strength and environmental protection offered by the jacket 270. This results in a cable that provides easier access to its subunits and is lighter, smaller, and less expensive than the one with the outer jacket 270. Also, it should be appreciated that the sub-cable jacket and the main cable jacket can be manufactured using polyethylene, polyvinylchloride (PVC), low-smoke zero halogen (LSZH), thermoplastic polyurethane (TPU), or other materials. Additionally, one having skill in the art will appreciate that a variety of sub-cable types can be used, such as, for example, rectangular drop cables or other types of round structures. All such changes, modifications, and alterations should therefore be seen as within the scope of the disclosure.

What is claimed is:

1. A system for providing fiber-optic connections to premises, the system comprising:
an outside plant (OSP) rated self-supporting main cable, the main cable comprising:
a strength element along a length of the main cable;
self-supporting OSP-rated break-out sub-cables positioned alongside the strength element, each sub-cable comprising:
optical fibers;
sub-cable reinforcing yarn positioned alongside the optical fibers; and
a sub-cable jacket surrounding the sub-cable reinforcing yarn, the sub-cable jacket further surrounding the optical fibers;
binder strands surrounding the sub-cables; and
a connector assembly optically coupled to one of the sub-cables.

2. The system of claim 1, the self-supporting cable further comprising a main cable jacket surrounding the binder strands.

3. The system of claim 1, the optical fibers in each sub-cable being arranged in a twelve (12) fiber close-packed matrix.

4. The system of claim 1, the sub-cables comprising a factory-terminated sub-cable mechanically connected to the connector assembly.

5. The system of claim 1, further comprising a drop cable optically coupled to the connector assembly.

6. A system, comprising:
a cable comprising:
a cable strength element positioned along a length of the cable;
a first sub-cable positioned alongside the cable strength element, the first sub-cable comprising:
a first sub-cable strength element; and
a first optical fiber; and
a second sub-cable positioned alongside the cable strength element, the second sub-cable comprising:
a second sub-cable strength element; and
a second optical fiber; and
a first connector assembly optically coupled to the first optical fiber.

7. The system of claim 6, the first sub-cable being an outside plant (OSP) rated cable.

8. The system of claim 6, the first sub-cable comprising m optical fibers, m being an integer, the m optical fibers being arranged in a substantially close-packed arrangement.

9. The system of claim 8, m being twelve (12), the m optical fibers being arranged in a twelve 12-fiber closely-packed matrix.

10. The system of claim 8, the first connector assembly comprising m optical connectors, each of the m optical connectors terminating a corresponding one of the m optical fibers.

11. The system of claim 6, further comprising a second connector assembly optically coupled to the second optical fiber.

12. The system of claim 6, the first sub-cable being a factory-terminated fiber-optic cable optically coupled to the first connector assembly.

13. The system of claim 6, the first connector assembly comprising a drop cable assembly connector.

14. The system of claim 6, further comprising binder strands surrounding the first sub-cable and the second sub-cable.

15. The system of claim 14, the binder strands being helically applied.

16. The system of claim 6, further comprising a drop cable optically coupled to the first sub-cable through the first connector assembly.

17. The system of claim 6, further comprising:
a drop cable; and
means for optically coupling the drop cable to the first sub-cable.

18. The system of claim 6, the first connector assembly comprising an optical connector selected from the group consisting of:
a multi-fiber connector;
a fan-out connector; and
a single-fiber connector.

19. A method, comprising:
determining a first termination location in a cable, the cable comprising a first self-supporting fiber-optic sub-cable, the cable further comprising a second self-supporting fiber-optic sub-cable;
terminating the first sub-cable at the first termination location; and
factory installing a first connector at the first termination location.

20. The method of claim 19, further comprising:
determining a second termination location in the cable;
terminating the second sub-cable at the second termination location; and
factory installing a second connector at the second termination location.
